(19) United States
(12) Patent Application Publication
(10) Pub. No.: US 2009/0100193 A1
(43) Pub. Date: Apr. 16, 2009

(54) Synchronization of state information to reduce APS switchover time

(75) Inventors: Kaarthik Natarajhan, Gugai (IN); Srikanth L., Munnekolala (IN); Midhun Somasundaran, San Jose, CA (US)

Correspondence Address: Cindy S. Kaplan, P.O. BOX 2448, SARATOGA, CA, 95070, US

(73) Assignee: CISCO TECHNOLOGY, INC., San Jose, CA (US)

(21) Appl. No.: 11/974,724

(22) Filed: Oct. 16, 2007

(51) Int. Cl. G06F 15/173

(52) U.S. Cl. 709/239

(57) ABSTRACT

In one embodiment, an apparatus includes a controller configured for operation in an active automatic protection switching (APS) mode and an inactive APS mode and a processor operable when the controller is in the active mode to transmit a synchronization message to a corresponding APS node. The synchronization message includes state information for a connection with a peer node. The processor is further operable when the controller is in inactive mode to receive the synchronization message from the corresponding APS node, switch the controller from inactive mode to active mode upon receiving notification of a failure from the corresponding APS node, and establish a connection with the peer node without negotiating the connection with the peer node. Methods for synchronization of state information to reduce APS switchover time are also disclosed.

### BACKGROUND OF THE INVENTION

The present disclosure relates generally to reducing Automatic Protection Switching (APS) switchover time.

Automatic Protection Switching is a means to provide SONET/SDH line redundancy. It is described in ITU-T Recommendation G.783 (“Characteristics of Synchronous Digital Hierarchy (SDH) Equipment Functional Blocks”, dated April 1997) and Bellcore GR-253 standard. The protocol provides high availability through SONET line redundancy by switching between two sections (working section and protection section). The sections may be configured, for example, with point-to-point protocol (PPP), multilink point-to-point protocol (MLPPP), or multilink frame relay (MFR).

With point-to-point protocol (PPP), both the sending and receiving devices negotiate or provision a connection or link by sending out LCP (link control protocol) packets to determine specific information that is required for data transmission. In order to establish communication over a point-to-point link, each end of the PPP link must first send LCP packets to configure and test the data link. Data cannot be transmitted over the network until the LCP packet determines the link is acceptable.

MLPPP allows multiple PPP links to be combined into a bundle creating a virtual link with an aggregate bandwidth that is greater than each of the individual links. MLPPP bundles configured with APS on a Sonet controller take a long time to bring up a new active interface in the case of an APS switchover. A considerable amount of time is spent on the member links to send out LCPs, negotiate, and bring up a connection. Any negotiation that happens after the APS switchover increases the net down time, which increases even further for distributed platforms.

### BRIEF DESCRIPTION OF THE DRAWINGS

FIG. 1 illustrates an example of a network in which embodiments described herein may be implemented.

FIG. 2 is a flowchart illustrating one example of a process for synchronization of state information to reduce APS switchover time from the perspective of an active controller.

FIG. 3 is a flowchart illustrating one example of a process for synchronization of state information to reduce APS switchover time from the perspective of an inactive controller.

FIG. 4 depicts an example of a network device useful in implementing embodiments described herein.

### DESCRIPTION OF EXAMPLE EMBODIMENTS

### Overview

An apparatus and method for synchronization of state information to reduce APS switchover time are disclosed.

In one embodiment, an apparatus generally comprises a controller configured for operation in an active automatic protection switching (APS) mode and an inactive APS mode and a processor operable when the controller is in active mode to transmit a synchronization message to a corresponding APS node. The synchronization message includes state information for a connection with a peer node. The processor is further operable when the controller is in inactive mode to receive the synchronization message from the corresponding APS node, switch the controller to active mode upon receiving notification of a failure from the corresponding APS node, and establish a connection with the peer node without negotiating the connection with the peer node.

In another embodiment, a method generally comprises receiving a synchronization message at an inactive APS node from an active APS node. The synchronization message comprises state information for a connection between the active APS node and a peer node. Upon receiving notification of a failure from the active APS node, a switchover is performed at the inactive APS node from inactive mode to active mode and the state information is used to establish a connection with the peer node without negotiating the connection with the peer node.

In yet another embodiment, a method generally comprises mapping an APS interface at an active node to a corresponding APS interface at an inactive node and generating a synchronization message at the active node. The synchronization message comprises state information for a connection between the active node and a peer node. The method further includes transmitting the synchronization message to the inactive node. The state information is configured for use by the inactive node in establishing a connection with the peer node without negotiating the connection with the peer node following a switchover at the inactive node from inactive mode to active mode.

### Example Embodiments

The following description is presented to enable one of ordinary skill in the art to make and use the invention. Descriptions of specific embodiments and applications are provided only as examples and various modifications will be readily apparent to those skilled in the art. The general principles described herein may be applied to other embodiments and applications without departing from the scope of the invention. Thus, the present invention is not to be limited to the embodiments shown, but is to be accorded the widest scope consistent with the principles and features described herein. For purpose of clarity, details relating to technical material that is known in the technical fields related to the invention have not been described in detail.

A method and system disclosed herein are used to synchronize state information to reduce Automatic Protection Switching (APS) switchover time. For example, the method and system may be used to make point-to-point protocol (PPP), multilink point-to-point protocol (MLPPP), or multilink frame relay (MFR) APS aware to reduce switchover time. Synchronization of state information between an active connection and inactive connection reduces time consumed in bringing up the inactive connection when the connections are APS redundant.

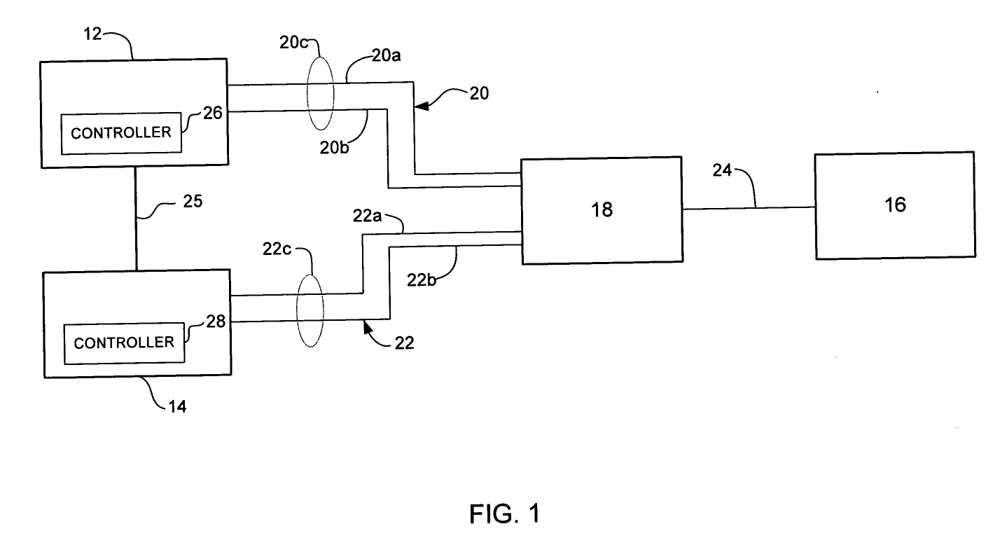

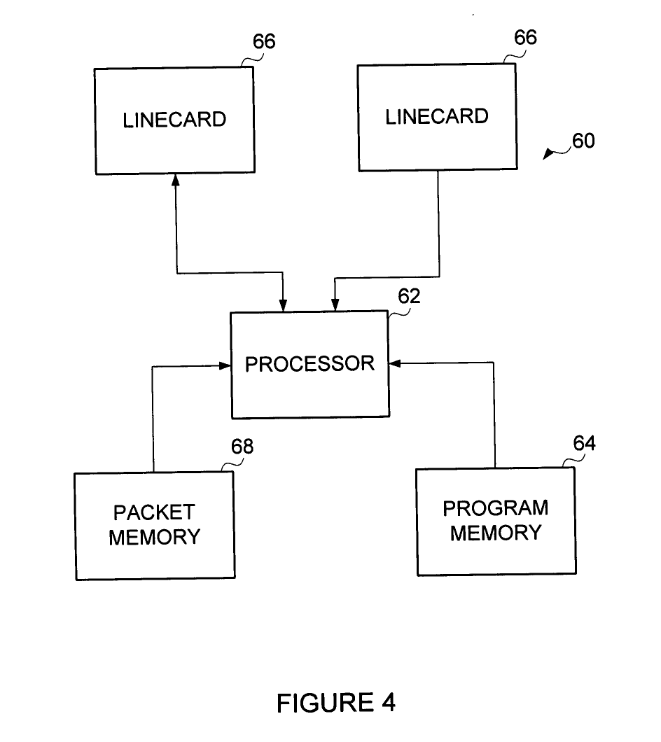

Referring now to the drawings, and first to FIG. 1, an example of a network that may implement embodiments described herein is shown. The embodiments operate in the context of a data communication network including multiple network elements. Some of the nodes in a network that employs the embodiments may be network devices such as routers or optical network system (ONS) devices such as an add-drop multiplexer (ADM). The network device may include, for example, a master central processing unit (CPU), interfaces, and a bus. The CPU preferably includes memory and a processor. The network device may be implemented on a general purpose network host machine such as a computer system or network device described below with respect to FIG. 4.

In the example shown in FIG. 1, network devices 12, 14, and 16 are routers and 18 is optical network system equipment, such as an add-drop multiplexer (ADM). Nodes 16 and 18 are connected by link 24. Nodes 12 and 18 communicate via a connection generally indicated at 20. Nodes 14 and 18 communicate via a connection generally indicated at 22. In one embodiment, connection 20 comprises links 20a, 20b, which are bundled together to form a MLPPP or MFR bundle 20c. Similarly, connection 22 may comprise links 22a, 22b, which are bundled together to form a MLPPP or MFR bundle 22c. The bundling of the physical interfaces, circuits, or links into one or more logical connections enables MLPPP and MFR to support more total bandwidth than is available on any single physical interface, circuit, or link. For example, MLPPP allows multiple PPP links to be combined into a bundle creating a virtual link with an aggregate bandwidth that is greater than each of the individual links. MFR provides improved bandwidth and reduced latency using a logical pipe consisting of bundled T1/E1 circuits transporting MFR fragments under the multilink frame relay protocol. In the example of FIG. 1, only two links are shown in each bundle, however, each bundle 20c, 22c may contain any number of links. Also, the connection 20, 22 may comprise a single link (20a, 22a) using point-to-point protocol. In the following description, connection 20, 22 may represent a single link (e.g., PPP link), MLPPP bundle, or MFR bundle, for example.

Nodes 12, 14, and 18 are configured for APS. Each router 12, 14 includes a controller 26, 28. In the example of FIG. 1, connection 20 is an active (working, primary) link and controller 26 is the active controller. Connection 22 is an inactive (protection, secondary, backup) link and controller 28 is the inactive controller. Each controller 26, 28 is configured to switch between an active mode and an inactive mode. One APS node is typically in active mode while the corresponding APS node is in inactive node. If a failure occurs at connection 20 (e.g., link or interface), traffic is routed to the backup connection 22 using APS. The active controller 26 switches to inactive mode and the inactive controller switches to active mode.

Routers 12 and 14 are connected by a communication link 25. In one embodiment, link 25 is an APS communication channel that is used to transfer APS information between routers 12 and 14, which are in the same APS group. The APS information may include Layer 1 information such as LOS (loss of signal) and alarm indications. The communication channel 25 may use, for example, protect group protocol (PGP). PGP is a protocol used for communication between working and protection APS configured devices. PGP updates are propagated bidirectionally between the working and protect routers 12, 14 to exchange information regarding the status of the node 18 interface. For example, if a failure occurs between nodes 12 and 18, the nodes will have knowledge of the failure through a loss of signal condition and PGP will notify router 14 that it will become the active interface. As described in detail below, the communication link 25 between nodes 12 and 14 is also used to transmit synchronization (sync) updates between active and inactive controllers 26, 28.

When node 12 is active it is in communication with node 16 through active APS connection 20 and link 24. Node 16 is a peer end node to ONS node 18 and is referred to herein generally as a peer node since it is one end of a communication link with nodes 12 and 14, when the nodes are in active mode. In the example of FIG. 1, the communication link (connection between active node 12 and peer node 16) comprises connection 20 (e.g., PPP, MLPPP, MFR connection) and link 24. It is to be understood that the connection between the active node 12 and peer node 16 may comprise any number and types of links and nodes.

The following describes the initial negotiation that occurs between router 12 and router 16 when a point-to-point link (e.g., 20a) first becomes active in order to establish an initial connection between node 12 and peer node 16. When bringing up a point-to-point link, PPP goes through several distinct phases. When an external event, such as carrier detection or network administrator configuration, indicates that the physical layer is ready to be used, PPP proceeds to a link establishment phase. A transition to this phase produces an UP event to the link control protocol, which provides several functions. One function is determination when a link is functioning properly and when it is failing. In order to establish communication over a point-to-point link, each end of the PPP link first sends LCP (link control protocol) packets to configure and test the data link. Data is not transmitted over the network until the LCP packet determines the link is acceptable.

With conventional MLPPP, a considerable amount of time is spent on the member links to negotiate the LCP come up. LCP has to be negotiated over the member links on the new active controller for the bundle to come up. At least one link's LCP has to be negotiated for this to occur. However, any negotiation that occurs after APS switchover increases the net down time.

The overhead of having member links 22a, 22b negotiate before the links 22a, 22b or the bundle 22c come up can be significantly reduced by keeping the member links 22a, 22b (connection 22) at the inactive controller 28 in the same state (sync) as the links 20a, 20b (connection 20) at the active controller 26 so that no negotiation is needed on the member links and the switchover remains transparent to the far end device 16.

In order to keep the member links 22a, 22b (connection 22) on the inactive controller 28 up, state information is maintained between the member links on each of the active and inactive APS links so that no time is spent on negotiating LCP on the member links, which in turn helps the connection come up quickly for an APS switchover. By syncing the active and inactive connections 20, 22, there is no renegotiation required on the member links and the new connection comes up very fast, thus reducing the time taken for APS switchover.

As described below, state information is maintained through a synchronization process which replicates the behavior of an active connection to an inactive connection. This makes the switchover transparent to the end node (peer node 16). In one embodiment, the PGP communication channel 25 is used to transfer synchronization updates from the active controller 26 to the inactive controller 28.

The state information synced between the active and inactive routers 12, 14 includes, for example, APS group, PPP session, and magic numbers. Magic numbers are randomly generated numbers used to identify the presence of a loop in a PPP connection. Each side silently discards control packets which have the same magic number. Some PPP implementations may detect a change in magic number as a sign of intrusion and might require re-negotiation of LCP and CHAP. In APS deployment, PPP control packets are received only on the active router.

In one embodiment, both PPP states and magic numbers are synced from the active router to the inactive router. This eliminates the need for LCP renegotiation by the PPP peer including the case due to magic number mismatch when an APS switchover takes place.

In one embodiment, a link ID is used to provide a map between the member links on the active controller 26 and the inactive controller 28 to provide a sync interface on the active router 12 with its corresponding interface in the inactive router 14. The link ID may be similar to the link ID used in MFR, for example, but not limited to such an explicit configuration. The link ID may be computed with respect to the interface within the SONET controller as long as it is uniquely and correctly identifiable within the APS group by the APS peer router. The configuration on the inactive connection 22 is configured to be generally the same as that on active connection 20.

In one embodiment, synchronization of the PPP state between interfaces on active and inactive controllers 26, 28 is performed by transmitting messages over PGP link 25. For these message/sync packets existing PGP messages can be extended or User Data Protocol (UDP) may be used for message transfer. The message may also be configured in a TLV format to accommodate additional information to be synced.

The following is one example of a format of the sync packet:

Sync {
aps_group
link_id
data_len
data
}

The sync updates may be event based or may be sent periodically. The following describes examples of events that may initiate synchronization:
the member link goes down and is renegotiated;
the member links are added or removed from a bundle;
member links are moved to other bundles;
after an APS switchover, the new inactive node comes back up and the current active node initiates the sync to the new inactive node.
   It is to be understood that the above list is only an example and that different events may be used to initiate a synchronization operation.

An embodiment in which MFR is used in place of MLPPP is similar to the MLPPP embodiment described above. ADD_LINK and ADD_LINK_ACK messages are transmitted between MFR member links and logically included in the bundle. As discussed above, renegotiation in a new active APS group device is avoided by syncing the states of member links, including, for example, magic numbers, from the node having the active APS group to the node having the inactive APS group. This ensures that the APS switchover is transparent to the MFR peer router on the other side of the ADM.

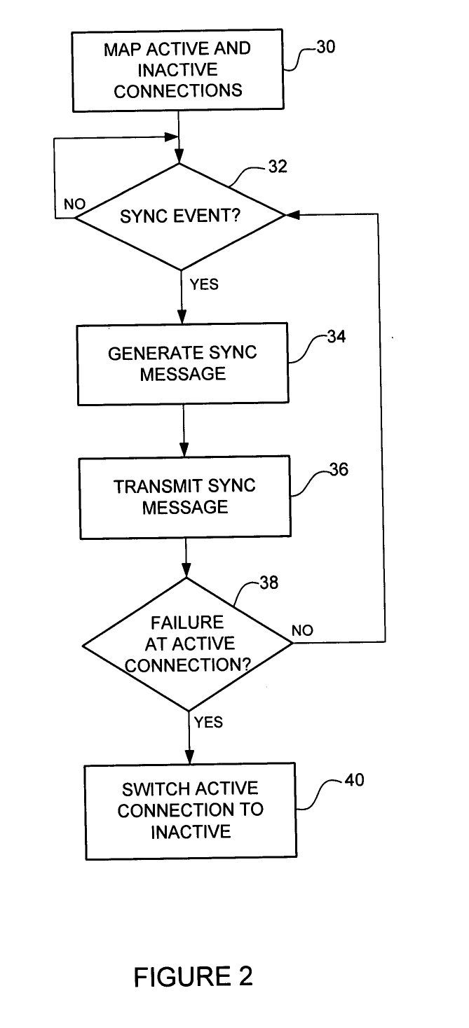

FIG. 2 is a flowchart illustrating one example of a process for synchronization of state information to reduce APS switchover time from the perspective of the active node 12. At step 30 connections 20, 22 are mapped on the active and inactive interfaces. If a sync event occurs (step 32), a synchronization message is generated at node 12 (step 34). As previously described, the synchronization message includes state information for the connection with peer node 16. The message is transmitted from active APS node 12 to corresponding inactive APS node 14 (step 36). As described above, the message may be transmitted using PGP, for example. If a failure occurs on the active connection (step 38), the working and protection links are switched, without requiring LCP re-negotiation with peer node 16 (step 40).

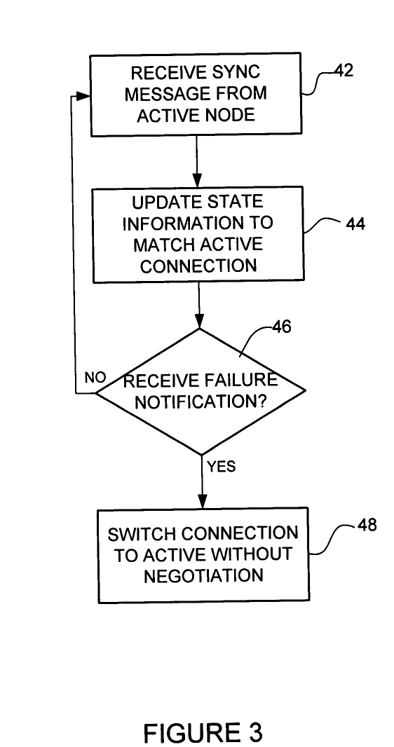

FIG. 3 is a flowchart illustrating one example of a process for synchronization of state information to reduce APS switchover time from the perspective of the inactive node 14. At step 42, the inactive node 14 receives a sync message from the active node 12 over link 25. The inactive node 14 updates its state information to match the active connection (step 44). If a failure occurs on the active connection 20, the connection 22 at the inactive router 14 is switched to an active connection without requiring renegotiation with its peer node (step 48).

FIG. 4 depicts a network device 60 that may be used to implement embodiments described herein. In one embodiment, network device 60 is a programmable machine that may be implemented in hardware, software, or any combination thereof. A processor 62 executes codes stored in a program memory 64. Program memory 64 is one example of a computer-readable medium. Program memory 64 can be a volatile memory. Another form of computer-readable medium storing the same codes would be some type of non-volatile storage such as floppy disks, CD-ROMs, DVD-ROMs, hard disks, flash memory, etc. A carrier wave that carries the code across the network is an example of a transmission medium.

Network device 60 interfaces with physical media via a plurality of linecards 66. Linecards 66 may incorporate Ethernet interfaces, DSL interfaces, Gigabit Ethernet interfaces, 10-Gigabit Ethernet interfaces, SONET interfaces, etc. As packets are received, processed, and forwarded by network device 60, they may be stored in a packet memory 68. To implement functionality according to the system, linecards 66 may incorporate processing and memory resources similar to those discussed above in connection with the network device as a whole.

Although the method and system have been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

What is claimed is:

1. A method comprising:
receiving a synchronization message at an inactive automatic protection switching (APS) node from an active APS node, said synchronization message comprising state information for a connection between the active APS node and a peer node; and
upon receiving notification of a failure from the active APS node, performing a switchover at the inactive APS node to active mode and utilizing said state information to establish a connection with the peer node without negotiating said connection with the peer node.

2. The method of claim 1 wherein said connection between the inactive node and the peer node comprises at least one point-to-point link and said state information comprises point-to-point protocol state information.

3. The method of claim 1 wherein said connection between the inactive node and the peer node comprises a multilink point-to-point protocol connection.

4. The method of claim 1 wherein said connection with the peer node is established without transmitting link control packets.

5. The method of claim 1 wherein receiving state information comprises receiving state information from a protect group protocol communication channel.

6. The method of claim 1 wherein said connection between the inactive node and the peer node comprises a multilink frame relay connection.

7. A method comprising:
mapping an automatic protection switching (APS) interface at an active node to a corresponding APS interface at an inactive node;
generating a synchronization message at the active node, said synchronization message comprising state information for a connection between the active node and a peer node; and
transmitting said synchronization message to the inactive node, wherein the state information is configured for use by the inactive node in establishing a connection with the peer node without negotiating said connection with the peer node following a switchover at the active node to inactive mode.

8. The method of claim 7 wherein mapping said interface at the active node to said interface at the inactive node comprises mapping one or more APS link IDs at the active node with one or more APS link IDs at the inactive node.

9. The method of claim 7 wherein said connection between the active node and the peer node comprises at least one point-to-point link and said state information comprises point-to-point protocol state information.

10. The method of claim 7 wherein said connection between the active node and the peer node comprises a multilink point-to-point protocol connection.

11. The method of claim 7 wherein transmitting state information comprises transmitting state information from a protect group protocol communication channel.

12. The method of claim 7 wherein said connection between the active node and the peer node comprises a multilink frame relay connection.

13. An apparatus comprising:
a controller configured for operation in an active automatic protection switching (APS) mode and an inactive APS mode; and
a processor operable when the controller is in said active mode to transmit a synchronization message to a corresponding APS node, said synchronization message comprising state information for a connection with a peer node;
the processor operable when the controller is in said inactive mode to receive said synchronization message from the corresponding APS node, upon receiving notification of a failure from the corresponding APS node, switch the controller from inactive mode to active mode, and establish a connection with the peer node without negotiating said connection with the peer node.

14. The apparatus of claim 13 wherein said connection with the peer node comprises at least one point-to-point link and said state information comprises point-to-point protocol state information.

15. The apparatus of claim 14 wherein said state information further comprises point-to-point protocol magic numbers.

16. The apparatus of claim 13 wherein said connection with the peer node comprises a multilink point-to-point protocol connection.

17. The apparatus of claim 13 wherein said synchronization message is configured for transmission over a protect group protocol communication channel.

18. The apparatus of claim 13 wherein said connection with the peer node comprises a multilink frame relay connection.

19. The apparatus of claim 13 wherein said synchronization message is transmitted upon the occurrence of an event when the controller is in said active mode.

20. The apparatus of claim 19 wherein said connection with the peer node is a multilink point-to-point protocol connection and said event is a change to member links within a multilink bundle of said connection.
